(19) United States
(12) Patent Application Publication
(10) Pub. No.: US 2014/0125129 A1
(43) Pub. Date: May 8, 2014

(54) ELECTRIC-POWER SUPPLY DEVICE, METHOD FOR OPERATING THE SAME AND COMPUTER-READABLE STORAGE MEDIUM

(71) Applicant: Shigeo UEDA, Kanagawa (JP)

(72) Inventor: Shigeo UEDA, Kanagawa (JP)

(73) Assignee: RICOH COMPANY, LIMITED, Tokyo (JP)

(21) Appl. No.: 14/065,556

(22) Filed: Oct. 29, 2013

(30) Foreign Application Priority Data
Nov. 8, 2012 (JP) 2012-246218
Jul. 5, 2013 (JP) 2013-142071
Oct. 10, 2013 (JP) 2013-213142

(51) Int. Cl. H02J 4/00

(52) U.S. Cl. CPC H02J 4/00
USPC 307/23

(57) ABSTRACT

An electric-power supply device including: an electric-power supply unit configured to receive external electric power supply and to supply a first electric power; at least one electric-power generating unit configured to generate a second electric power; an electricity storing unit configured to store the second electric power; and a controller configured to control charging and discharging of the electricity storing unit and to control electric power supply, wherein the controller, in the normal mode, selects one of electric-power generating unit according to predetermined priorities assigned to the at least one electric-power generating unit, and the controller causes the electricity storing unit to charge the second electric power generated by the selected electric-power generating unit, and the controller, in the energy saving mode, terminates electric-power supply and causes the electricity storing unit to discharge electric-power causes the electricity storing unit to supply the second electric power.

### CROSS-REFERENCE TO RELATED APPLICATIONS

The present application claims priority to and incorporates by reference the entire contents of Japanese Patent Application No. 2012-246218 filed in Japan on Nov. 8, 2012, Japanese Patent Application No. 2013-142071 filed in Japan on Jul. 5, 2013 and Japanese Patent Application No. 2013-213142 filed in Japan on Oct. 10, 2013.

### BACKGROUND OF THE INVENTION

1. Field of the Invention

The present invention relates generally to an electric-power supply device, an image forming apparatus, an electric-power supply method, and a computer-readable storage medium.

2. Description of the Related Art

Office equipment, such as a multifunction peripheral, typically has a mode that stops supplying electric power to inactive functional blocks of the equipment and/or slows down operations in order to reduce standby electric-power consumption. Such an operation mode is referred to as energy saving mode, for example.

Furthermore, there is a technique for further reducing electric power consumption in the energy saving mode by utilizing an electric-power generating unit, such as a solar cell, that generates electric power from energy other than electric power, and an electricity storing unit (a storage battery, a secondary cell). An example of such a technique is disclosed in Japanese Patent Application Laid-open No. 2011-205787. More specifically, in a normal mode, the electricity storing unit is charged with electric power generated by the solar cell or the like. In the energy saving mode, external alternating-current (AC) power supply is turned off, and circuits are operated on electric power stored in the electricity storing unit.

Meanwhile, there can be a situation where office equipment, for example, is equipped with a plurality of electric-power generating units that generate electric power from energy other than electric power. The office equipment may include, for example, a solar cell and a thermoelectric conversion unit that generates electric power from heat. In such a situation, the electric-power generating units generally differ from each other in efficiency in conversion to electric power. Accordingly, it becomes necessary to determine from which one of the electric-power generating units electric power should be supplied to the electricity storing unit.

In light of the foregoing, there is a need to provide an electric-power supply device, an image forming apparatus, an electric-power supply method, and a computer-readable storage medium for charging an electricity storing unit efficiently, thereby reducing consumption of externally-supplied electric power when a main operating unit is operating in an energy saving mode.

It is an object of the present invention to at least partially solve the problem in the conventional technology.

### SUMMARY OF THE INVENTION

It is an object of the present invention to at least partially solve the problems in the conventional technology.

According to an aspect of the invention, an electric-power supply device that supplies electric power to a main operating unit capable of operating in an energy saving mode where the main operating unit operates on less electric power than in a normal mode is provided. The electric-power supply device includes: an electric-power supply unit configured to receive external electric power supply and to supply a first electric power to the main operating unit; at least one electric-power generating unit configured to generate a second electric power from energy other than electric power; an electricity storing unit connected to the at least one electric-power generating unit, the electricity storing unit configured to store the second electric power; and a controller connected to the electric power supply, the at least one electric-power generating unit and the electricity storing unit, the controller configured to control charging and discharging of the electricity storing unit and to control electric power supply to the main operating unit, wherein the controller, when the main operating unit is operating in the normal mode, selects one of electric-power generating unit from the at least one of electric-power generating unit according to predetermined priorities assigned to the at least one electric-power generating unit, and the controller causes the electricity storing unit to charge the second electric power generated by the selected electric-power generating unit and the controller, when the main operating unit is operating in the energy saving mode and a remaining electric-power amount in the electricity storing unit is no less than a predetermined threshold value, terminates electric-power supply and the controller causes the electricity storing unit to discharge electric-power and the controller causes the electricity storing unit to supply the second electric power to the main operating unit.

According to another aspect of the invention, a method for operating an electric-power supply device that supplies electric power to a main operating unit capable of operating in an energy saving mode where the main operating unit operates on less electric power than in a normal mode is provided. The electric-power supply device includes: an electric-power supply unit configured to receive external electric power supply and to supply a first electric power to the main operating unit; at least one electric-power generating unit configured to generate a second electric power from energy other than electric power; an electricity storing unit connected to the at least one electric-power generating unit, the electricity storing unit configured to store the second electric power; and a controller connected to the electric power supply, the at least one electric-power generating unit and the electricity storing unit, the controller configured to control charging and discharging of the electricity storing unit and to control electric power supply to the main operating unit. The method includes: by the controller, selecting one of electric-power generating unit from the at least one of electric-power generating unit according to the predetermined priorities assigned to the at least one electric-power generating unit, when the main operating unit is operating in the normal mode; by the controller, causing the electricity storing unit to charge the second electric power generated by the selected electric-power generating unit; by the controller, terminating electric-power supply and causing the electricity storing unit to discharge electric-power; and by the controller, causing the electricity storing unit to supply the second electric power to the main operating unit, when the main operating unit is operating in the energy saving mode and the remaining electric-power amount in the electricity storing unit is no less than the predetermined threshold value.

According to further aspect of the invention, a computer readable medium including a computer program product, the computer program product comprising instructions which, when executed by a computer, causes the computer to perform operation of an electric-power supply device that supplies electric power to a main operating unit capable of operating in an energy saving mode where the main operating unit operates on less electric power than in a normal mode is provided. The electric-power supply device includes: an electric-power supply unit configured to receive external electric power supply and to supply a first electric power to the main operating unit; at least one electric-power generating unit configured to generate a second electric power from energy other than electric power; an electricity storing unit connected to the at least one electric-power generating unit, the electricity storing unit configured to store the second electric power; and a controller connected to the electric power supply, the at least one electric-power generating unit and the electricity storing unit, the controller configured to control charging and discharging of the electricity storing unit and to control electric power supply to the main operating unit. The operation includes: selecting one of electric-power generating unit from the at least one of electric-power generating unit according to the predetermined priorities assigned to the at least one electric-power generating unit, when the main operating unit is operating in the normal mode; causing the electricity storing unit to charge the second electric power generated by the selected electric-power generating unit; terminating electric-power supply and causing the electricity storing unit to discharge electric-power; and causing the electricity storing unit to supply the second electric power to the main operating unit, when the main operating unit is operating in the energy saving mode and the remaining electric-power amount in the electricity storing unit is no less than the predetermined threshold value.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of an image forming apparatus according to an embodiment;

FIG. 2 is a diagram illustrating a first example of priorities assigned to supply sources, from which selection as electric power for charging an electricity storing unit is to be made;

FIG. 3 is a diagram illustrating a second example of priorities assigned to the supply sources, from which selection as electric power for charging the electricity storing unit is to be made;

FIG. 4 is a diagram illustrating a procedure flow for an electric-power supply unit in a normal mode;

FIG. 5 is a diagram illustrating a procedure flow in an energy saving mode;

FIG. 6 is a diagram illustrating a configuration of an image forming apparatus according to a modification of the embodiment; and

FIG. 7 is a diagram illustrating a procedure flow for the electric-power supply unit in an energy saving mode according to the modification.

### DETAILED DESCRIPTION OF THE PREFERRED EMBODIMENTS

An exemplary embodiment is described in detail below with reference to the accompanying drawings. The embodiment is not intended to limit the scope of the present invention.

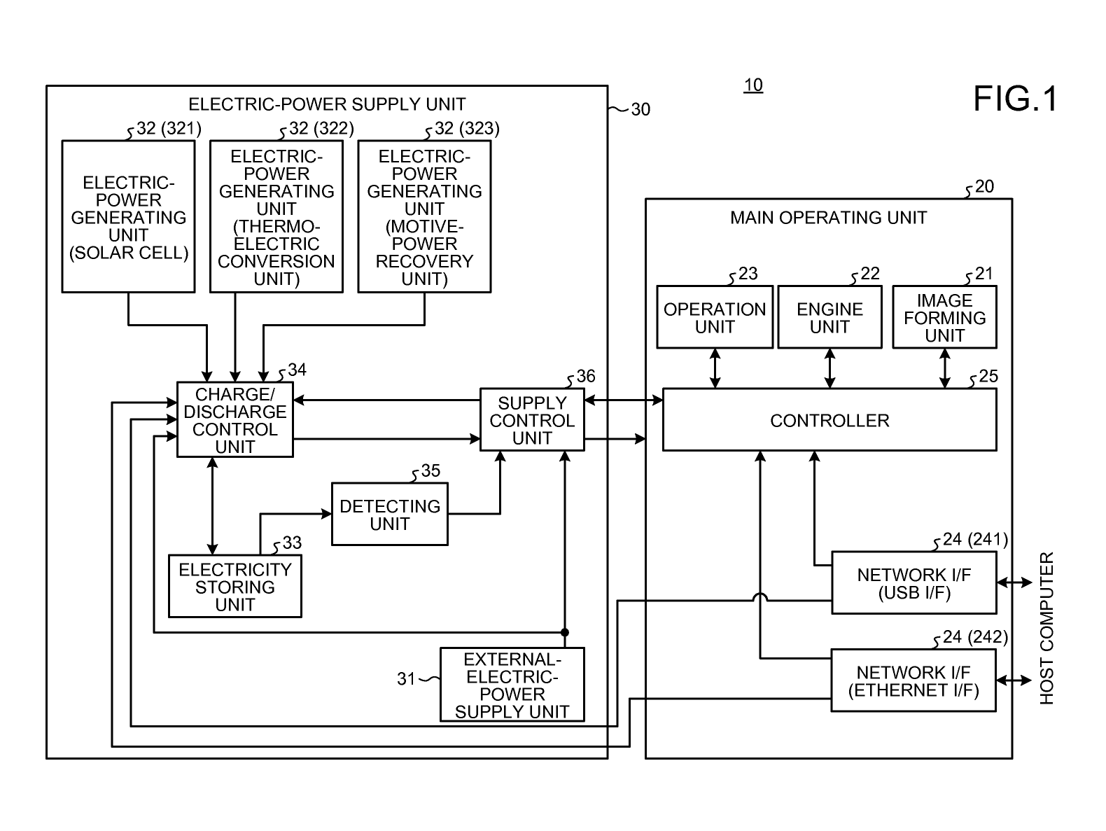

FIG. 1 is a diagram illustrating a configuration of an image forming apparatus 10 according to the embodiment. The image forming apparatus 10 receives image data and a print command from a host computer and prints an image on a media sheet according to the received image data.

The image forming apparatus 10 includes a main operating unit 20 and an electric-power supply unit 30. The main operating unit 20 has primary functions of the image forming apparatus 10. The main operating unit 20 includes, for example, an image forming unit 21, an engine unit 22, an operation unit 23, one or more network interfaces (I/Fs) 24, and a controller 25.

The image forming unit 21 forms an image on a media sheet according to image data received from the external host computer. The image forming unit 21 includes, for example, a rotary drum and a fixing unit. An image is formed with toner on a surface of the rotary drum that is rotating. The image formed with the toner on the surface is transferred onto the media sheet. The fixing unit heats the toner or the like transferred onto the media sheet, thereby fixing the image formed with the toner onto the media sheet.

The engine unit 22 performs data processing, e.g., converting the image data received from the external host computer into print data. The operation unit 23 receives an operation input entered by a user.

Each of the one or more network interfaces 24 is connected to the host computer over a network. Each of the one or more network interfaces 24 transmits and receives image data, a command, and the like to and from the host computer.

The main operating unit 20 includes, for example, a universal serial bus (USE) interface (I/F) 241 and an Ethernet (registered trademark) interface (I/F) 242 as the network interfaces 24. The USE interface 241 provides connection with the host computer via a USE bus. The Ethernet interface 242 provides connection with the host computer via an Ethernet bus.

The one or more network interfaces 24 allow receiving external electric power supply, which depends on the network standard. For example, the USE interface 241 allows receiving electric power supply via a USE power-supply bus line. For another example, the Ethernet interface 242 allows receiving electric power supply transmitted in accordance with the standard referred to as Power over Ethernet (PoE).

The controller 25 is a central processing unit (CPU), for example, and controls operations of the entire image forming apparatus 10. For example, when the controller 25 receives a print command from the host computer through one of the network interfaces 24, the controller 25 causes the image forming unit 21 to start a printing operation.

The main operating unit 20 configured as described above is capable of operating in a normal mode and in an energy saving mode. In the normal mode, direct-current (DC) power is supplied to every functional block of the main operating unit 20, and the every functional block operates at its normal speed. By contrast, in the energy saving mode, the main operating unit 20 stops supplying DC power to some of the functional blocks that are inactive and/or slows down operations of functional blocks that are relatively less busy. The main operating unit 20 operates in the energy saving mode in this manner, whereby electric power consumption can be reduced as compared with the normal mode.

The controller 25 switches from the normal mode to the energy saving mode when, for example, an operation command is not received from the host computer for a constant period of time or longer or when an instruction to switch to the energy saving mode is provided from an operator via the operation unit 23. The controller 25 also switches from the energy saving mode to the normal mode when a return command is received from the host computer or when a return instruction is provided from an operator via the operation unit 23.

The electric-power supply unit 30 functions as an electric-power supply device that supplies DC power to circuits in the main operating unit 20. The electric-power supply unit 30 supplies DC power also to circuits in the electric-power supply unit 30.

The electric-power supply unit 30 includes an external-electric-power supply unit 31, a plurality of electric-power generating units 32, an rechargeable battery unit 33, a charge/discharge control unit 34, a detecting unit 35, and a supply control unit 36.

The external-electric-power supply unit 31 receives externally-supplied AC power, converts it into DC power, and supplies the DC power to the circuits of the main operating unit 20 via the supply control unit 36. The external-electric-power supply unit 31 supplies the DC power also to the charge/discharge control unit 34.

Each of the plurality of electric-power generating units 32 generates electric power from energy other than electric power. The electric-power supply unit 30 includes, as the plurality of electric-power generating units 32, a solar cell 321, a thermoelectric conversion unit 322, and a motive-power recovery unit 323, for example.

The solar cell 321 generates electric power from light. For example, the solar cell 321 converts solar light or light of an electric lamp or the like emitted from outside of the image forming apparatus 10 into electric power by using a photoelectric conversion device.

The thermoelectric conversion unit 322 generates electric power from heat. The thermoelectric conversion unit 322 converts a temperature difference between a high-temperature member of the fixing unit, which is a heat source, and another, low-temperature member into electric power by using a thermoelectric conversion device that utilizes the Seebeck effect, for example.

The motive-power recovery unit 323 generates electric power from braking energy of a rotation source. The motive-power recovery unit 323 converts, for example, braking energy of the rotary drum or the like into electric power.

The rechargeable battery unit 33 stores electric power. The rechargeable battery unit 33 is a storage battery (secondary cell), for example. The charge/discharge control unit 34 controls electric power charging and discharging of the rechargeable battery unit 33.

The charge/discharge control unit 34 charges the rechargeable battery unit 33 with electric power generated by one of the plurality of electric-power generating units 32. The charge/discharge control unit 34 is also capable of charging the rechargeable battery unit 33 with electric power supplied through the network interface 24 in the main operating unit 20. The charge/discharge control unit 34 is also capable of charging the rechargeable battery unit 33 with electric power supplied via the external-electric-power supply unit 31.

The charge/discharge control unit 34 also discharges the electric power stored in the rechargeable battery unit 33 and supplies the electric power to the circuits in the main operating unit 20 via the supply control unit 36. The charge/discharge control unit 34 may discharge the electric power stored in the rechargeable battery unit 33 and supply the electric power to the circuits in the electric-power supply unit 30 via the supply control unit 36.

The detecting unit 35 detects a remaining amount of the electric power stored in the rechargeable battery unit 33.

The supply control unit 36 controls electric power supply to the main operating unit 20. More specifically, the supply control unit 36 supplies electric power from the external-electric-power supply unit 31 to the main operating unit 20 when the main operating unit 20 is operating in the normal mode. The supply control unit 36 supplies electric power from the external-electric-power supply unit 31 to the main operating unit 20 also when the main operating unit 20 is operating in the energy saving mode and the remaining electric-power amount in the rechargeable battery unit 33 is lower than a predetermined threshold value.

However, when the main operating unit 20 is operating in the energy saving mode and the remaining electric-power amount in the rechargeable battery unit 33 is equal to or higher than the predetermined threshold value, the supply control unit 36 causes the electric power stored in the rechargeable battery unit 33 to be supplied to the main operating unit 20 rather than supplying electric power from the external-electric-power supply unit 31 to the main operating unit 20. By performing control in this way, the supply control unit 36 can reduce consumption of externally-supplied electric power when the main operating unit 20 is in the energy saving mode and the remaining electric-power amount in the rechargeable battery unit 33 is equal to or higher than the threshold value.

The supply control unit 36 may control electric power supply to the circuits in the electric-power supply unit 30 as in the case of electric power supply to the main operating unit 20.

In a situation where the main operating unit 20 is operating in the normal mode or a situation where the main operating unit 20 is operating in the energy saving mode on electric power from the external-electric-power supply unit 31, the supply control unit 36 selects an electric-power generation source for use as a charging source of the rechargeable battery unit 33. The supply control unit 36 then causes the rechargeable battery unit 33 to be charged with electric power generated by the selected electric-power generation source.

More specifically, if electric power is generated by any one of the plurality of electric-power generating units 32 (for example, the solar cell 321, the thermoelectric conversion unit 322, and the motive-power recovery unit 323), the supply control unit 36 selects one of the plurality of electric-power generating units 32, and causes the rechargeable battery unit 33 to be charged with electric power generated by the selected electric-power generating unit 32. If electric power is generated by none of the plurality of electric-power generating units 32, the supply control unit 36 selects one of the one or more network interfaces 24 (for example, the USE interface 241 and the Ethernet interface 242), and causes the rechargeable battery unit 33 to be charged with electric power generated by the selected network interface 24. If none of the one or more network interfaces 24 is generating electric power, the supply control unit 36 causes the rechargeable battery unit 33 to be charged with electric power supplied via the external-electric-power supply unit 31.

Meanwhile, the supply control unit 36 assigns a priority that indicates a precedence level in selection to each of the plurality of electric-power generating units 32, the one or more network interfaces 24, and the external-electric-power supply unit 31 in advance. The supply control unit 36 selects a single electric-power generation source according to the assigned priorities, and charges the rechargeable battery unit 33 with electric power from the selected electric-power generation source.

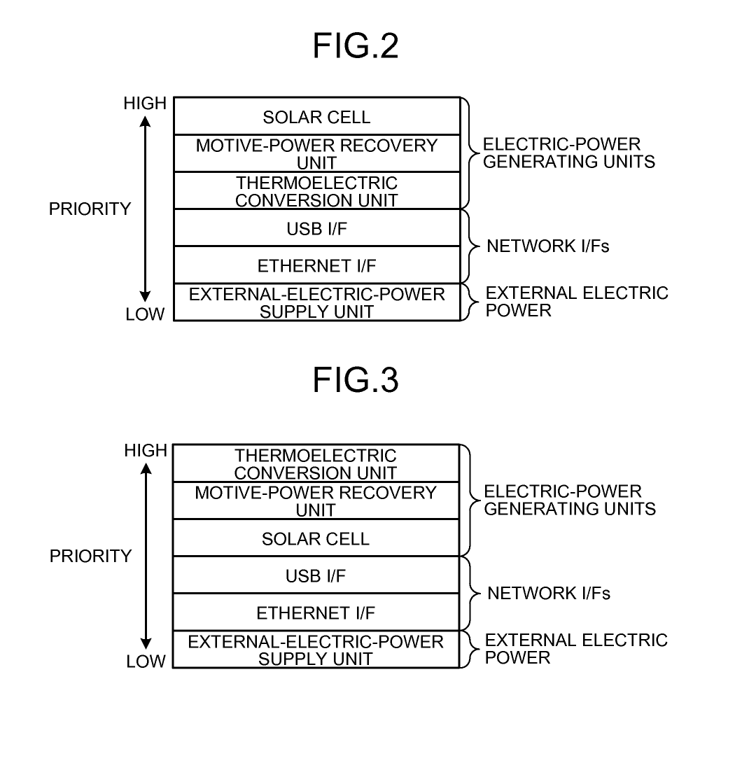

For instance, as illustrated in FIG. 2, the supply control unit 36 may assign a highest priority to the plurality of electric-power generating units 32, a next highest priority to the network interfaces 24, and a lowest priority to the external-electric-power supply unit 31. In this case, the supply control unit 36 can cause the rechargeable battery unit 33 to be charged with electric power generated from energy other than electric power with higher priority. As a result, the image forming apparatus 10 can reduce electric power consumption in the energy saving mode even to substantially zero.

The supply control unit 36 may cause the priorities assigned to the plurality of electric-power generating units 32 to vary from energy source to energy source. The supply control unit 36 may assign priorities in such a manner that, for instance, the priority increases as efficiency in conversion to electric power (hereinafter, “electric-power conversion efficiency”) increases. For example, the supply control unit 36 may measure an amount of electric power generated over a predetermined period of time by each of the plurality of electric-power generating units 32 and calculate electric-power conversion efficiencies from the measurement result. The supply control unit 36 may assign priorities based on the calculated electric-power conversion efficiencies. In the example illustrated in FIG. 2, the supply control unit 36 assigns a highest priority to the solar cell 321, a next highest priority to the motive-power recovery unit 323, and a lowest priority to the thermoelectric conversion unit 322.

The supply control unit 36 may change the priority assignment depending on time of day. For example, the supply control unit 36 may assign a higher priority to the solar cell 321 at daytime as illustrated in FIG. 2, but assign a lower priority to the solar cell 321 at nighttime as illustrated in FIG. 3. In this case, the supply control unit 36 can select the electric-power generating unit 32 that is high in electric-power conversion efficiency invariably even if electric-power conversion efficiency varies depending on the time of day. The supply control unit 36 may change the priority assignment depending on a surrounding condition of the image forming apparatus 10 instead of or in addition to depending on the time of day.

The supply control unit 36 may change the priority assignment depending on an operation (e.g., a job to be executed according to a received command) performed by the main operating unit 20. For example, the supply control unit 36 may assign a higher priority to the thermoelectric conversion unit 322 as illustrated in FIG. 3 when the temperature of the fixing unit is high because the main operating unit 20 is executing a print job or the like, but assign a lower priority to the thermoelectric conversion unit 322 as illustrated in FIG. 2 when the temperature of the fixing unit is low because the main operating unit 20 is not executing a print job. In this case, the supply control unit 36 can select the electric-power generating unit 32 that is high in electric-power conversion efficiency invariably even if electric-power conversion efficiency varies depending on an operating condition. The supply control unit 36 may change the priorities depending on a status of the image forming apparatus 10 in place of or in addition to depending on the operation performed by the main operation unit 20.

In a case where electric power is suppliable through two or more of the network interfaces 24, the supply control unit 36 assigns priorities to the two or more network interfaces 24 in such a manner that the higher the suppliable amount, the higher the priority. In this case, the supply control unit 36 can select the network interface 24 that can provide faster charging speed with higher priority. The supply control unit 36 may assign a priority that is higher than a priority assigned to one of the electric-power generating units 32 to the network interfaces 24 depending on the surrounding condition or the status of the image forming apparatus 10.

The image forming apparatus 10 may arrange the plurality of electric-power generating units 32, the rechargeable battery unit 33, and the charge/discharge control unit 34 outside a casing of the apparatus or configure them detachable. In this case, in an event of failure of any one of the plurality of electric-power generating units 32, the rechargeable battery unit 33, and the charge/discharge control unit 34, the image forming apparatus 10 allows the failed unit to be replaced.

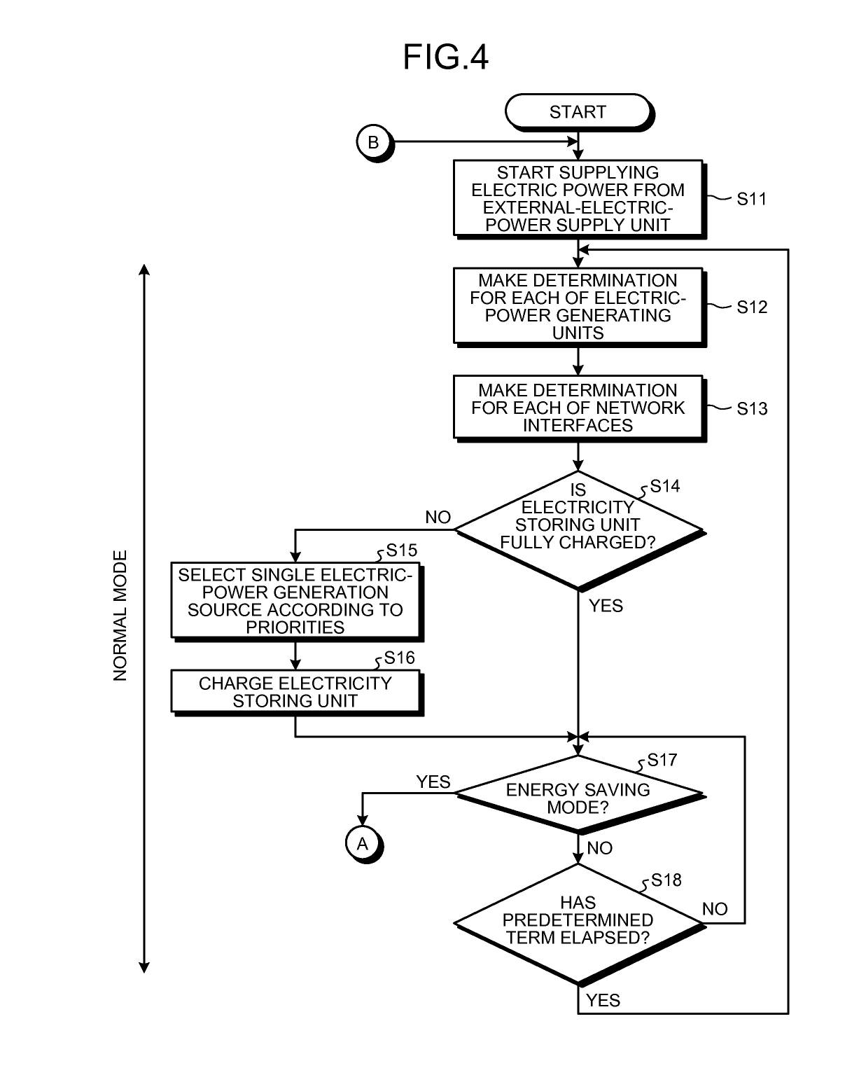

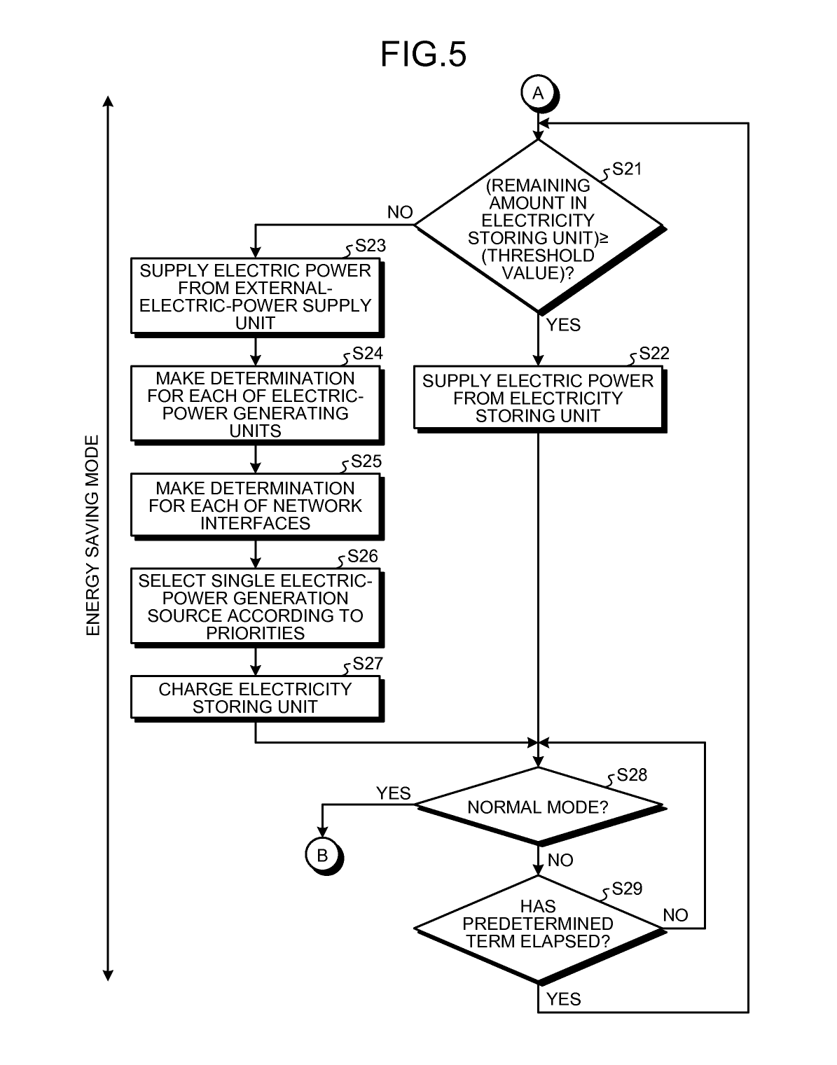

FIG. 4 is a diagram illustrating a procedure flow for the electric-power supply unit 30 in the normal mode. FIG. 5 is a diagram continuing from FIG. 4 and illustrating a procedure flow for the energy saving mode.

When the image forming apparatus 10 starts up, the supply control unit 36 of the electric-power supply unit 30 supplies electric power from the external-electric-power supply unit 31 to the main operating unit 20 (Step S11). Accordingly, the main operating unit 20 operates on the external electric power (e.g., external, commercial AC power supply).

The main operating unit 20 is initialized after the startup and then starts operating in the normal mode. When the main operating unit 20 receives a print command or the like from the host computer in the normal mode, the main operating unit 20 causes the image forming unit 21 to perform image forming.

Subsequently, the supply control unit 36 determines, for each of the plurality of electric-power generating units 32, whether the electric-power generating unit 32 is generating electric power (Step S12). Subsequently, the supply control unit 36 determines, for each of the one or more network interfaces 24, whether electric power is supplied through the network interface 24 (Step S13).

Subsequently, the supply control unit 36 determines whether the rechargeable battery unit 33 is fully charged (Step S14). If the rechargeable battery unit 33 is fully charged (Yes in Step S14), the supply control unit 36 causes the procedure to proceed to Step S17. If the rechargeable battery unit 33 is not fully charged (No in Step S14), the supply control unit 36 causes the procedure to proceed to Step S15.

Subsequently, the supply control unit 36 selects a single electric-power generation source from a plurality of electric-power generation sources (which are the electric-power generating unit(s) 32 determined as generating electric power in Step S12, the network interface(s) 24 determined as supplying electric power in Step S13, and the external-electric-power supply unit 31) according to the assigned priorities (Step S15).

For example, when the time of day is daytime, the supply control unit 36 selects a single electric-power generation source having a highest priority among the plurality of electric-power generation sources according to the priorities in the list illustrated in FIG. 2. For another example, when the time of day is nighttime, the supply control unit 36 selects a single electric-power generation source having a highest priority among the plurality of electric-power generation sources according to the priorities in the list illustrated in FIG. 3.

Subsequently, the supply control unit 36 causes the rechargeable battery unit 33 to be charged with electric power generated by the selected single electric-power generation source (Step S16).

Subsequently, the supply control unit 36 determines whether the main operating unit 20 has entered the energy saving mode (Step S17). The main operating unit 20 goes from the normal mode into the energy saving mode when, for example, no command is received from the host computer for the constant period of time or when an operation for switching to the energy saving mode is performed by a user.

If the main operating unit 20 has not entered the energy saving mode (No in Step S17), the supply control unit 36 causes the procedure to proceed to Step S18. In Step S18, the supply control unit 36 determines whether a predetermined term (e.g., a period necessary for fully charging the rechargeable battery unit 33) has elapsed. If the predetermined term of time has not elapsed (No in Step S18), the supply control unit 36 causes the procedure to proceed to Step S17. Thus, the supply control unit 36 holds the procedure at Step S17 and at Step S18 until the main operating unit 20 goes into the energy saving mode or until the predetermined term of time elapses.

If the predetermined term of time has elapsed (Yes in Step S18), the supply control unit 36 causes the procedure to return to Step S12. By performing control in this manner, the supply control unit 36 can repeat the procedure from Step S12 to Step S16 at fixed time intervals. Accordingly, the supply control unit 36 can continue charging until the rechargeable battery unit 33 is fully charged. Moreover, even if electric power supply from the selected electric-power generation source is stopped, the supply control unit 36 can switch to another electric-power generation source and perform charging.

If the main operating unit 20 has entered the energy saving mode (Yes in Step S17), the supply control unit 36 causes the procedure to proceed to Step S21 of FIG. 5 to thereby switch to the procedure for the energy saving mode.

In Step S21, the supply control unit 36 determines whether the remaining amount in the rechargeable battery unit 33 is equal to or higher than the threshold value.

If the remaining amount in the rechargeable battery unit 33 is equal to or higher than the threshold value (Yes in Step S21), the supply control unit 36 causes the procedure to proceed to Step S22. In Step S22, the supply control unit 36 causes charging of the rechargeable battery unit 33 to be stopped. The supply control unit 36 causes the external-electric-power supply unit 31 to stop supplying electric power to the main operating unit 20 and, simultaneously, causes the rechargeable battery unit 33 to start supplying electric power to the main operating unit 20. On completion of the process in Step S22, the supply control unit 36 causes the procedure to proceed to Step S28.

If the remaining amount in the rechargeable battery unit 33 is lower than the threshold value (No in Step S21), the supply control unit 36 causes the procedure to proceed to Step S23. In Step S23, if electric power is supplied from the external-electric-power supply unit 31 to the main operating unit 20, the supply control unit 36 causes this electric power supply to continue. If electric power is supplied from the rechargeable battery unit 33 to the main operating unit 20, the supply control unit 36 causes the external-electric-power supply unit 31 to start electric power supply to the main operating unit 20 so as to take the place of electric power supply from the rechargeable battery unit 33.

Subsequently, the supply control unit 36 determines, for each of the plurality of electric-power generating units 32, whether the electric-power generating unit 32 is generating electric power (Step S24). Subsequently, the supply control unit 36 determines, for each of the one or more network interfaces 24, whether the network interface 24 is supplying electric power (Step S25).

Subsequently, the supply control unit 36 selects a single electric-power generation source from the plurality of electric-power generation sources (which are the electric-power generating unit(s) 32 determined as generating electric power in Step S24, the network interface(s) 24 determined as supplying electric power in Step S25, and the external electric-power supply unit 31) according to the assigned priorities (Step S26). Subsequently, the supply control unit 36 causes the rechargeable battery unit 33 to be charged with electric power generated by the selected single electric-power generation source (Step S27). On completion of the process in Step S27, the supply control unit 36 causes the procedure to proceed to Step S28.

In Step S28, the supply control unit 36 determines whether the main operating unit 20 has received a command to return to the normal mode. The main operating unit 20 returns from the energy saving mode to the normal mode when, for instance, the main operating unit 20 receives a return command from the host computer or from an operator via the operation unit 23.

If the main operating unit 20 has not received a command to return to the normal mode (No in Step S28), the supply control unit 36 causes the procedure to proceed to Step S29. In Step S29, the supply control unit 36 determines whether the predetermined term of time has elapsed. If the predetermined term of time has not elapsed (No in Step S29), the supply control unit 36 causes the procedure to proceed to Step S28. Thus, the supply control unit 36 holds the procedure at Step S28 and at Step S29 until the main operating unit 20 receives a command to return to the normal mode or until the predetermined term of time elapses.

If the predetermined term of time has elapsed (Yes in Step S29), the supply control unit 36 causes the procedure to return to Step S21. By performing control in this manner, the supply control unit 36 can repeat the procedure from Step S21 to Step S27 at fixed time intervals. Accordingly, the supply control unit 36 can perform discharging when the remaining amount in the rechargeable battery unit 33 is equal to or higher than the threshold value, but perform charging when the remaining amount is lower than the threshold value. Moreover, even if electric power supply from the selected electric-power generation source is stopped, the supply control unit 36 can switch to another electric-power generation source and perform charging.

If the main operating unit 20 has received a command to return to the normal mode (Yes in Step S28), the supply control unit 36 causes the procedure to proceed to Step S11 of FIG. 4 to thereby switch to the procedure for the normal mode.

As described above, the image forming apparatus 10 according to the embodiment selects one of the electric-power generating units 32 according to the assigned priorities, and causes the selected electric-power generating unit 32 to charge the rechargeable battery unit 33. Therefore, the image forming apparatus 10 can charge the rechargeable battery unit 33 efficiently. Consequently, the image forming apparatus 10 can reduce consumption of externally-supplied electric power when the main operating unit 20 is operating in the energy saving mode.

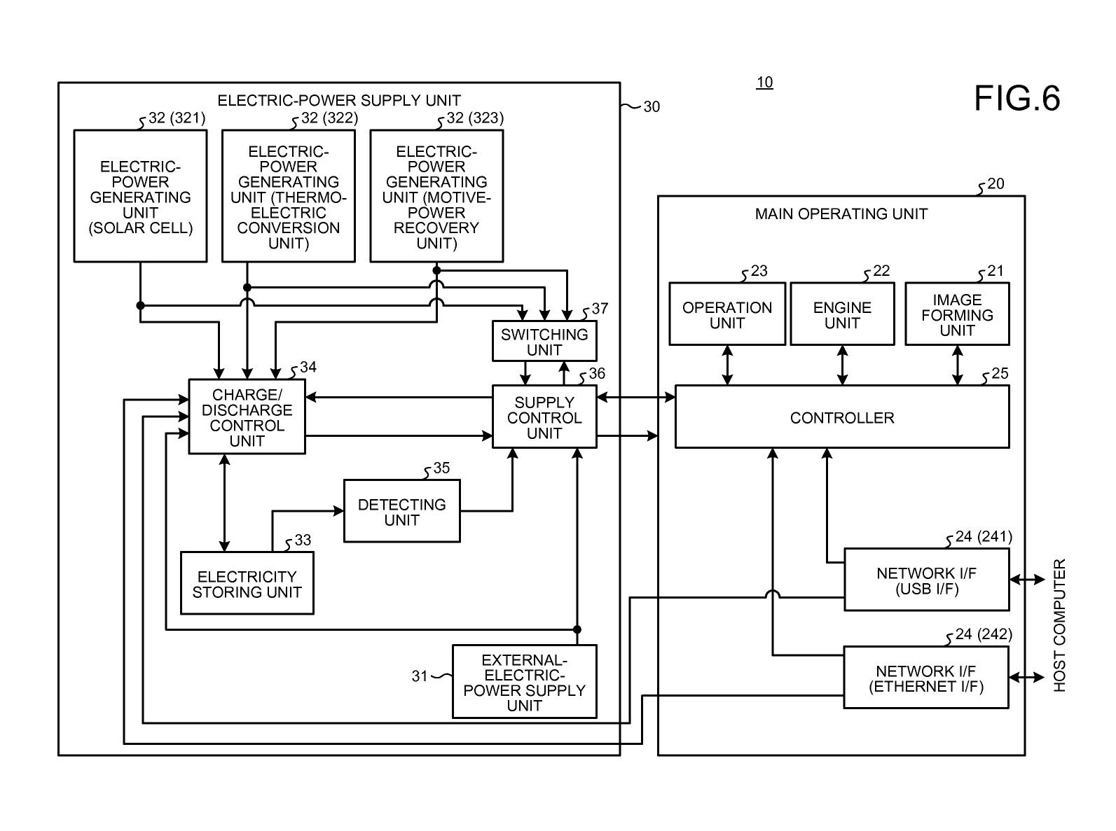

FIG. 6 is a diagram illustrating a configuration of the image forming apparatus 10 according to a modification of the embodiment. The modification has functions and configuration that are substantially same as those of the basic configuration of the embodiment described above with reference to FIGS. 1 to 5. Members substantially identical in function and configuration as those of the embodiment are denoted by like reference numerals, and points where the modification differs from the embodiment are mainly described below.

The electric-power supply unit 30 according to the modification further includes a switching unit 37. The switching unit 37 selects one of the plurality of electric-power generating units 32 in accordance with control performed by the supply control unit 36. The switching unit 37 supplies electric power from the selected electric-power generating unit 32 to the main operating unit 20 via the supply control unit 36.

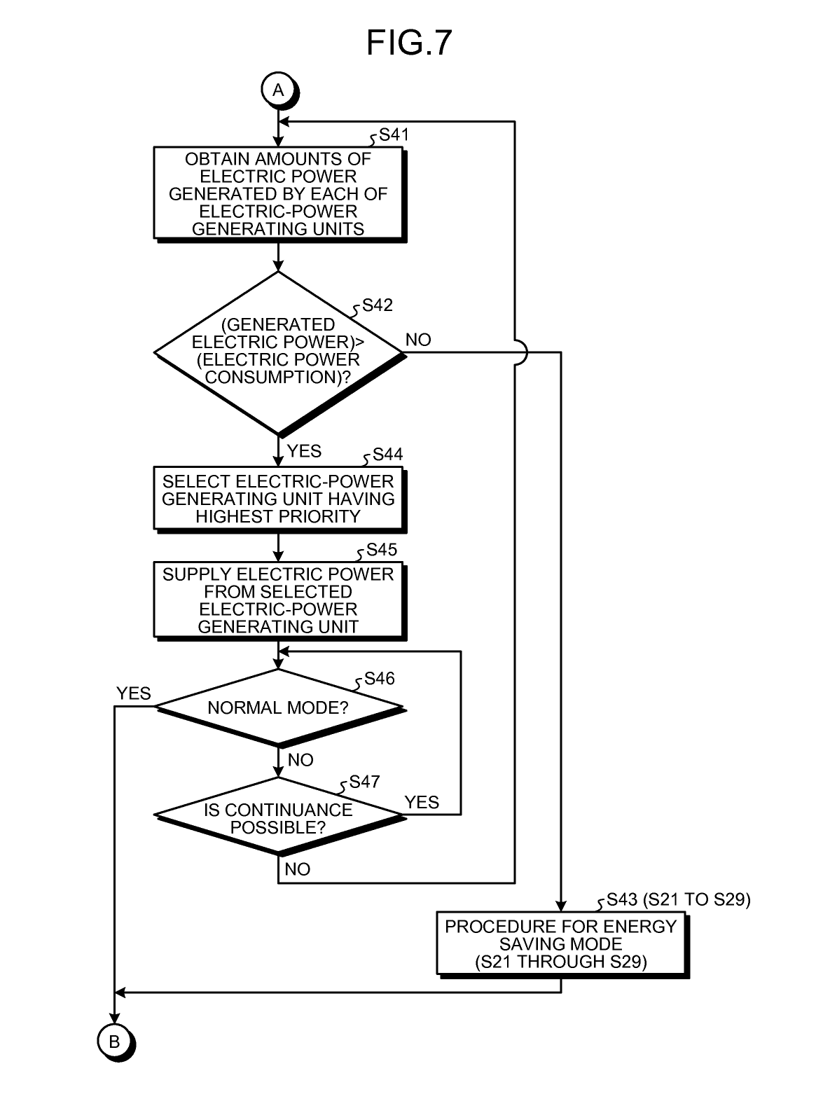

FIG. 7 is a diagram illustrating a procedure flow for the electric-power supply unit 30 in an energy saving mode according to the modification. The electric-power supply unit 30 according to the modification performs the procedure flow illustrated in FIG. 7 rather than the procedure flow illustrated in FIG. 5 when the main operating unit 20 has entered the energy saving mode.

First, the supply control unit 36 of the electric-power supply unit 30 obtains amounts of electric power generated by each of the plurality of electric-power generating units 32 (for example, the solar cell 321, the thermoelectric conversion unit 322, and the motive-power recovery unit 323) (Step S41). Subsequently, the supply control unit 36 determines whether any one of the plurality of electric-power generating units 32 is generating electric power equal to or higher than electric power consumption of the main operating unit 20 (Step S42).

If none of the plurality of electric-power generating units 32 is generating electric power equal to or higher than the electric power consumption of the main operating unit 20 (No in Step S42), the supply control unit 36 causes the procedure to proceed to Step S43. In Step S43, the supply control unit 36 performs the procedure for the energy saving mode from Steps S21 to S29 illustrated in FIG. 5.

On the other hand, if one or more of the plurality of electric-power generating units 32 are generating electric power equal to or higher than the electric power consumption of the main operating unit 20 (Yes in Step S42), the supply control unit 36 causes the procedure to proceed to Step S44. In Step S44, the supply control unit 36 selects the electric-power generating unit 32 having a highest priority among the one or more electric-power generating units 32 that are generating electricity equal to or higher than the electricity consumption of the main operating unit 20.

Subsequently, the supply control unit 36 causes electric power generated by the selected electric-power generating unit 32 to be supplied to the main operating unit 20 (Step S45). By performing control in this manner, the supply control unit 36 can cause the main operating unit 20 to operate on electric power generated by one of the electric-power generating units 32 in the energy saving mode.

Subsequently, in Step S46, the supply control unit 36 determines whether the main operating unit 20 has received a command to return to the normal mode. If the main operating unit 20 has not received a command to return to the normal mode (No in Step S46), the supply control unit 36 causes the procedure to proceed to Step S47. In Step S47, the supply control unit 36 determines whether electric power generated by the selected electric-power generating unit 32 is sufficient for the main operating unit 20 to continue operating (Step S47). More specifically, the supply control unit 36 determines whether the electric power generated by the selected electric-power generating unit 32 is higher than the electric power consumption of the main operating unit 20.

If the electric power generated by the selected electric-power generating unit 32 is sufficient for the main operating unit 20 to continue operating (Yes in Step S47), the supply control unit 36 causes the procedure to return to Step S46. Thus, the supply control unit 36 holds the procedure at Step S46 and at Step S47 until the main operating unit 20 receives a command to return to the normal mode or until the electric power generated by the selected electric-power generating unit 32 becomes insufficient for the main operating unit 20 to continue operating.

If the electric power generated by the selected electric-power generating unit 32 is insufficient for the main operating unit 20 to continue operating (No in Step S47), the supply control unit 36 causes the procedure to proceed to Step S41. By performing control in this manner, if there is another electric-power generating unit 32 which is generating the power greater than the power for operating the main operation unit 20, the other electric-power generating unit 32 can operate the main operation unit 20. On the other hands, if there is not another electric-power generating unit 32 which is generating the power greater than the power for operating the main operation unit 20, the supply control unit 36 may determine “no” at step S42 and proceed the procedure to Step S43.

If the main operating unit 20 has received a command to return to the normal mode (Yes in Step S46), the supply control unit 36 causes the procedure to proceed to Step S11 of FIG. 4 to thereby switch to the procedure for the normal mode.

As described above, when the main operating unit 20 is operating in the energy saving mode and the electric power generated by the electric-power generating unit 32 selected according to the priorities is equal to or higher than the electric power consumption of the main operating unit 20, the supply control unit 36 causes electric power generated by the electric-power generating unit 32 selected according to the priorities to be supplied to the main operating unit 20 rather than causing the external-electric-power supply unit 31 to supply electric power to the main operating unit 20. Accordingly, the image forming apparatus 10 can reduce consumption of externally-supplied electric power when the main operating unit 20 is operating in the energy saving mode.

Instructions to be executed by the image forming apparatus 10 of the embodiment have a modular structure made up of blocks that control the units (the charge/discharge control unit 34, the detecting unit 35, and the supply control unit 36) described above. From a viewpoint of hardware, the image forming apparatus 10 includes a CPU, a read only memory (ROM), and a random access memory (RAM). The CPU reads out the instructions from the ROM onto a main storage device and executes the instructions, thereby implementing the charge/discharge control unit 34, the detecting unit 35, and the supply control unit 36.

The instructions to be executed by the image forming apparatus 10 of the embodiment may be provided as being stored in advance in the ROM, for example. The instructions to be executed by the image forming apparatus 10 of the embodiment may be provided as a file of an installable format or an executable format recorded in a non-transitory computer-readable storage medium such as a compact disc-read-only memory (CD-ROM), a flexible disk, a CD-recordable (CD-R), or a digital versatile disk (DVD).

The instructions to be executed by the image forming apparatus 10 of the embodiment may be stored in a computer connected to a network such as the Internet and provided by downloading over the network. The instructions to be executed by the image forming apparatus 10 of the embodiment may be provided or distributed over a network such as the Internet.

The image forming apparatus 10 according to the embodiment may be a multifunction peripheral having at least one function of a printing function, a copying function, a scanner function, and a facsimile function.

In the embodiment, electric-power supply control in the image forming apparatus 10 has been described; however, the present invention is not limited thereto. For instance, the electric-power supply unit 30 may be applied to a display apparatus such as a projector, an information processing apparatus such as a personal computer, or an information terminal such as a smartphone or a portable terminal.

According to an aspect of the embodiment, it is possible to charge an electricity storing unit efficiently, thereby reducing consumption of externally-supplied electric power when a main operating unit is operating in an energy saving mode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric-power supply device that supplies electric power to a main operating unit capable of operating in an energy saving mode where the main operating unit operates on less electric power than in a normal mode, the electric-power supply device comprising:
an electric-power supply unit configured to receive external electric power supply and to supply a first electric power to the main operating unit;
at least one electric-power generating unit configured to generate a second electric power from energy other than electric power;
an electricity storing unit connected to the at least one electric-power generating unit, the electricity storing unit configured to store the second electric power; and
a controller connected to the electric power supply, the at least one electric-power generating unit and the electricity storing unit, the controller configured to control charging and discharging of the electricity storing unit and to control electric power supply to the main operating unit, wherein
the controller, when the main operating unit is operating in the normal mode, selects one of electric-power generating unit from the at least one of electric-power generating unit according to predetermined priorities assigned to the at least one electric-power generating unit, and the controller causes the electricity storing unit to charge the second electric power generated by the selected electric-power generating unit and
the controller, when the main operating unit is operating in the energy saving mode and a remaining electric-power amount in the electricity storing unit is no less than a predetermined threshold value, terminates electric-power supply and the controller causes the electricity storing unit to discharge electric-power and the controller causes the electricity storing unit to supply the second electric power to the main operating unit.

2. The electric-power supply device set forth in claim 1, wherein when the main operating unit is operating in the energy saving mode and the electric-power supply unit is supplying electric power to the main operating unit, the controller causes the electricity storing unit to charge electric power generated by the selected electric-power generating unit.

3. The electric-power supply device set forth in claim 1, wherein the controller changes the priorities according to time.

4. The electric-power supply device set forth in claim 1, wherein the controller changes the priorities according to an operation performed by the main operating unit.

5. The electric-power supply device set forth in claim wherein the first electric-power is AC electric-power.

6. The electric-power supply device set forth in claim 1, wherein when the main operating unit is operating in the normal mode and none of the at least one of electric-power generating units is generating the second electric power, the controller causes the electricity storing unit to charge electric power supplied through an interface for data transmission/reception.

7. The electric-power supply device set forth in claim 1, wherein when the main operating unit is operating in the energy saving mode and the electric power generated by the selected electric-power generating unit is no less than electric power consumption of the main operating unit, the controller supplies the second electric power generated by the selected electric-power generating unit instead of the electric-power supply unit.

8. A method for operating an electric-power supply device that supplies electric power to a main operating unit capable of operating in an energy saving mode where the main operating unit operates on less electric power than in a normal mode,
the electric-power supply device comprising:
an electric-power supply unit configured to receive external electric power supply and to supply a first electric power to the main operating unit;
at least one electric-power generating unit configured to generate a second electric power from energy other than electric power;
an electricity storing unit connected to the at least one electric-power generating unit, the electricity storing unit configured to store the second electric power; and
a controller connected to the electric power supply, the at least one electric-power generating unit and the electricity storing unit, the controller configured to control charging and discharging of the electricity storing unit and to control electric power supply to the main operating unit,
the method comprising:
by the controller, selecting one of electric-power generating unit from the at least one of electric-power generating unit according to the predetermined priorities assigned to the at least one electric-power generating unit, when the main operating unit is operating in the normal mode;
by the controller, causing the electricity storing unit to charge the second electric power generated by the selected electric-power generating unit;
by the controller, terminating electric-power supply and causing the electricity storing unit to discharge electric-power; and
by the controller, causing the electricity storing unit to supply the second electric power to the main operating unit, when the main operating unit is operating in the energy saving mode and the remaining electric-power amount in the electricity storing unit is no less than the predetermined threshold value.

9. A computer readable medium including a computer program product, the computer program product comprising instructions which, when executed by a computer, causes the computer to perform operation of an electric-power supply device that supplies electric power to a main operating unit capable of operating in an energy saving mode where the main operating unit operates on less electric power than in a normal mode,
the electric-power supply device comprising:
an electric-power supply unit configured to receive external electric power supply and to supply a first electric power to the main operating unit;
at least one electric-power generating unit configured to generate a second electric power from energy other than electric power;
an electricity storing unit connected to the at least one electric-power generating unit, the electricity storing unit configured to store the second electric power; and
a controller connected to the electric power supply, the at least one electric-power generating unit and the electricity storing unit, the controller configured to control charging and discharging of the electricity storing unit and to control electric power supply to the main operating unit,
the operation comprising:
selecting one of electric-power generating unit from the at least one of electric-power generating unit according to the predetermined priorities assigned to the at least one electric-power generating unit, when the main operating unit is operating in the normal mode;
causing the electricity storing unit to charge the second electric power generated by the selected electric-power generating unit;
terminating electric-power supply and causing the electricity storing unit to discharge electric-power; and
causing the electricity storing unit to supply the second electric power to the main operating unit, when the main operating unit is operating in the energy saving mode and the remaining electric-power amount in the electricity storing unit is no less than the predetermined threshold value.
